(19) United States
(12) Patent Application Publication
(10) Pub. No.: US 2007/0040858 A1
(43) Pub. Date: Feb. 22, 2007

(54) Systems, methods and apparatuses for sensing ink container and ink presence

(75) Inventors: Michael Clark Campbell, Lexington, KY (US); Mahesan Chelvayohan, Lexington, KY (US); Gina Marie Johns, Nicholasville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/206,610

(22) Filed: Aug. 17, 2005

(51) Int. Cl. B41J 2/195

(52) U.S. Cl. 347/7

(57) ABSTRACT

The presence of an ink container and the presence of ink within an ink container may be detected using an ink container having prisms thereon. The detection of both an ink container and ink within a container may be executed in a single step using an light source that projects light toward a carriage or position operative to retain an ink container. The amount of reflected light received by a detector is measured. Based on the measurement of the amount of reflected light received by the detector, a determination is made as to whether an ink container is present in the carriage and if so, whether the ink container contains ink

### FIELD OF THE INVENTION

The present invention relates generally to optical sensing systems, and more particularly, to systems, methods and apparatuses for identifying ink container and ink presence.

### BACKGROUND OF THE INVENTION

In conventional printers, copiers, and multi-function products, it is often important to determine if ink remains in an ink container to determine whether a device is ready for use and to extend the life of a printhead. Failure to accurately determine if ink remains in a tank can result in severe damage to the printhead when an attempt is made to print without any ink.

Some devices use drop counting to determine if ink remains in an ink container. However, those systems are often inaccurate and unreliable. Where multiple ink containers are used, a single stationary sensor may be employed to detect the presence of ink in ink containers brought in front of the sensor. For this method to be effective, an ink container must be reliably positioned in a carriage and positioned in front of the sensor. This typically requires sensing of the presence of the container. Detection of the presence of a container is sometimes used to prevent printing without a container, which may result in damage to a printhead.

To effect detection of both container and ink presence, different sensing surfaces have been added to the container—one to sense the ink presence and the other to sense the container presence. This requires the sensing of two locations on the container and the moving of the container, or the use of two separate sensors. Therefore, what is needed is a simplified method and apparatus for detecting both the presence of a container and the presence of ink within a container.

### BRIEF SUMMARY OF THE INVENTION

According to the present invention, the presence of an ink container and the presence of ink within an ink container may be detected using an ink container having prisms thereon. The detection of both an ink container and ink within a container may be executed in a single step using an optical light that projects light from the source toward a carriage or position operative to retain an ink container. The amount of reflected light received by a detector is measured. Based on the measurement of the amount of reflected light received by the detector, a determination is made as to whether an ink container is present in the carriage and if so, whether the ink container contains ink

According to one embodiment of the present invention, there is disclosed a method of detecting the presence of an ink container and ink therein. The method includes projecting light from a source toward a carriage, where the carriage is operative to retain an ink container, measuring an amount of reflected light received by a detector, and determining, based on the measurement of the amount of reflected light received by the detector, whether an ink container is present in the carriage and if so, whether the ink container contains ink.

According to an aspect of the invention, determining further includes determining whether the measurement of the amount of reflected light exceeds a first threshold, where the first threshold is indicative of the presence or absence of the ink container in the carriage. According to another aspect of the invention, determining further includes determining whether the measurement of the amount of reflected light exceeds a second threshold, where the second threshold is indicative of the presence or absence of ink in the ink container. According to yet another aspect, projecting light may also include projecting light onto an ink container retained by the carriage, where the ink container includes a plurality of optical structures having planar surfaces generally parallel to at least one surface of the ink container.

Projecting light may also include projecting light onto an ink container retained by the carriage, where the ink container includes a plurality of optical structures having planar surfaces oriented at an angle with respect to least one surface of the ink container. According to another aspect of the invention, the optical structures may be trapezoidal in shape or trapezoidal in cross section.

According to another embodiment of the invention, there is disclosed a system for detecting the presence of an ink container and ink therein. The system includes a light source operative to project light toward a location operable to retain an ink container having an ink reservoir for retaining ink, a detector operative to receive any light reflected from the location, and means for determining, based on the measurement of the amount of reflected light received by the detector, whether an ink container is present in the location and if so, whether the ink container contains ink.

According to an aspect of the invention, the system may also include an ink container having at least one optical structure, and the location may be a carriage operable to retain the ink container. According to another aspect of the invention, the at least one optical structure may be a prism. The prism may have a trapezoidal cross section, and may protrude from at least one substantially planar surface of the ink reservoir. According to another aspect of the invention, the prism may include a first face generally parallel to the at least one substantially planar surface of the ink reservoir, and a second face oriented at an angle with respect to the least one substantially planar surface of the ink reservoir.

According to yet another embodiment of the invention, there is disclosed an ink container. The ink container includes an ink reservoir operable to retain ink, and

a plurality of optical structures, each of said optical structures including a plurality of substantially planar faces, where a first face of the plurality of substantially planar faces is generally parallel to at least one surface of the ink reservoir, and where a second face of the plurality of substantially planar faces is oriented at an angle with respect to least one surface of the ink reservoir.

According to an aspect of the invention, each of the plurality of optical structures are substantially trapezoidal in shape or cross section. According to another aspect of the invention, the plurality of optical structures are operable to reflect or refract at least a portion of light projected thereon to indicate the presence of ink in the ink reservoir. The plurality of optical structures may also be operable to reflect at least a portion of light projected thereon to indicate the presence of the plurality of optical structures. According to yet another aspect of the invention, the plurality of optical structures may be positioned directly adjacent a face of the ink reservoir. Furthermore, each of the plurality of optical structures may be trapezoidal in shape.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a side view of an illustrative ink container having a plurality of optical structures, according to an embodiment of the present invention.

FIG. 2 is a perspective view of an illustrative ink container, according to an embodiment of the present invention.

FIG. 3 is a perspective view of an illustrative ink container, according to an embodiment of the present invention.

FIG. 4 is a side view of three optical structures of the ink container shown in FIG. 1, according to embodiments of the present invention.

FIG. 5 is an illustrative ink and container presence detection system including an ink container having ink therein, according to an embodiment of the present invention.

FIG. 6 is an illustrative ink and container presence detection system including an ink container having no ink therein, according to an embodiment of the present invention.

FIG. 7 is a block diagram flow chart of an ink and container presence detection method, according to an illustrative embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

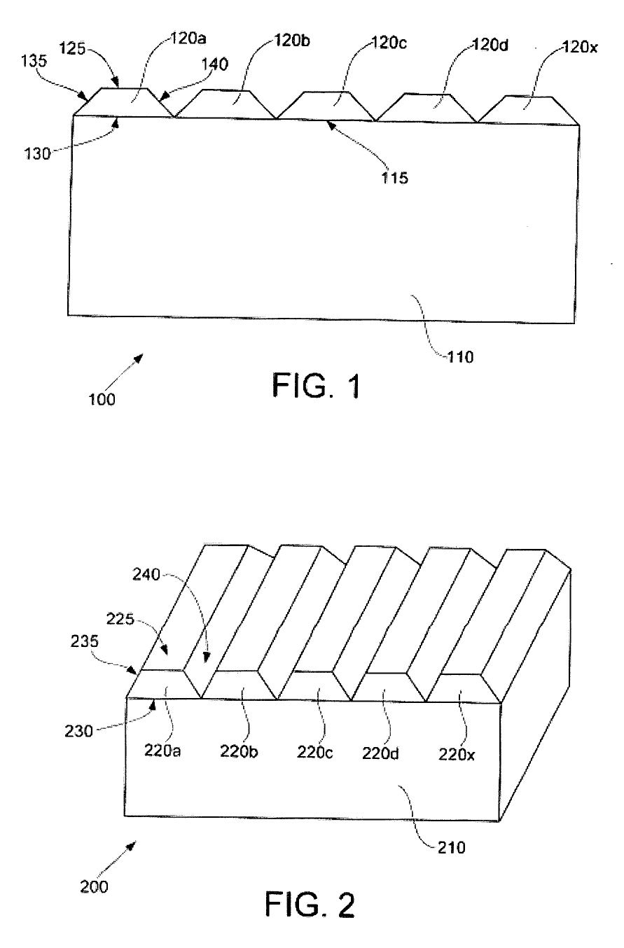

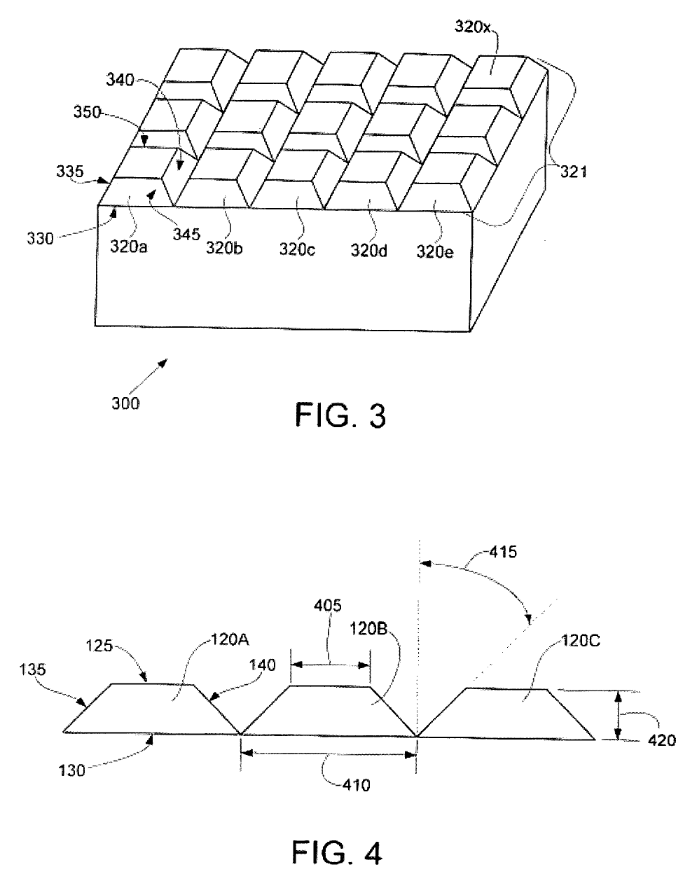

FIG. 1 is a side view of an illustrative ink container 100 including a reservoir 110 and a plurality of optical structures 120a, 120b, . . . , 120x, according to an embodiment of the present invention. The ink container 100 shown in FIG. 1 may be used in an optical sensing system, where the ink container 100 is positioned in front of an optical sensor. In particular, the plurality of optical structures 120a, 120b, . . . , 120x may be placed in front of the sensor to receive light emitted there from. Briefly, the optical structures 120a, 120b, . . . , 120x function as miniature prisms to reflect and refract incident light projected onto the container 100 to identify the presence of the container 100 and whether the container 100 contains ink in the reservoir 110, as is explained in detail below with respect to FIGS. 3 and 4.

The optical structures 120a, 120b, . . . , 120x shown in FIG. 1 are trapezoidal in cross section. Each includes a generally planar upper surface 125 and lower surface 130. The lower surface 130 of the optical structures may be shared with a top surface of the reservoir 110. Each optical structure also includes at least two planar sloped sides 135, 140. The optical structures 120a, 120b, . . . , 120x may be constructed of plastic, glass, polypropylene, or a similar refractive material, as is known in the art, and may be formed simultaneously with the reservoir 110, or formed separately from the reservoir 110 and later combined with the reservoir 110 such as via insert molding or ultrasonic welding. For instance, the optical structures 120a, 120b, . . . , 120x may be inserted into a floor or side of an ink container, which is constructed separately from the optical structures, which may be advantageous for manufacturing optical structures with high quality and consistency. According to another aspect of the invention, the optical structures 120a, 120b, . . . , 120x and ink container may be molded together and constructed from copolymer polypropylene.

FIG. 2 is a perspective view of an illustrative ink container 200, according to an embodiment of the present invention. It will be appreciated that the ink container 200 shown in FIG. 2 includes several optical structures 220a, 220b, . . . , 220x having a trapezoidal cross section similar to the cross section of the optical structures 120a, 120b, . . . , 120x of FIG. 1. Each of the optical structures positioned on one side of the ink reservoir 210 are elongated, such that the planar upper surface 225 and sloped sides 235, 240 are typically greater in length than the respective end faces of the optical structures. Although illustrated as covering an entire area of the ink container 200, it should be appreciated that the optical structures 220 may cover only a portion of a surface 230 of the ink reservoir 210. Therefore, the optical structures may only span a partial length and/or width of a surface of the ink container 200. Additionally, as in FIG. 1, although five (5) optical structures 220 are illustrated, a greater or lesser number of optical structures may be used to implement the present invention.

FIG. 3 is a perspective view of another illustrative ink container 300 according to an embodiment of the present invention. The ink container 300 shown in FIG. 3 includes an array 321 of optical structures 320a, 320b, . . . , 320x having a trapezoidal cross section similar to the cross section of the optical structures 120a, 120b, . . . , 120x in FIG. 1 and the optical structures 220a, 220b, . . . , 220x in FIG. 2. Each optical structure 320a, 320b, . . . , 320x shown in the illustrative embodiment of FIG. 3 includes four sloped sides 335, 340, 345, 350 that are generally planar and may be oriented at similar angles with respect to a corresponding upper surface 325 of an optical structure. Thus, the cross section of the optical structures 320a, 320b, . . . , 320x may be trapezoidal shape lengthwise or widthwise along the optical structures 320a, 320b, . . . , 320x. Like the embodiment described with respect to FIG. 2, although illustrated as covering an entire area of the ink container 300, the optical structures 320a, 320b, . . . , 320x may cover only a portion of a surface 331 of the ink reservoir 310. Therefore, the optical structures 320a, 320b, . . . , 320x may only span a partial length and/or width of a surface of the ink container 300. Additionally, as in FIGS. 1 and 2, although fifteen (15) optical structures 320a, 320b, . . . , 320x are illustrated in the embodiment of FIG. 3, a greater or fewer number of optical structures may be used to implement the present invention.

FIG. 4 shows a side view of three optical structures 120a, 120b, 120c of the ink container 100 illustrated in FIG. 1. According to an embodiment of the invention, the upper surface 125 of each optical structure 120a, 120b, 120c may be approximately 0.5 mm in width 405, while the lower surface 130 is approximately 1.0 mm in width 410. The height 420 of each side, measured as the shortest distance between the upper surface 125 and lower surface 130, may be approximately 0.25 mm, and the length of each structure may be approximately 5 mm. Additionally, the angle 415 formed by each side 135, 140 with respect to the plane of the lower surface 130, or from a 90 degree angle to the lower surface 130, may be approximately 45 degrees.

According to another embodiment of the present invention, the upper surface 125 of each optical structure 120a, 120b, 120c may be approximately 0.7 mm in width 405, while the lower surface 130 is approximately 1.0 mm in width 410. The height 420 of each side, measured as the shortest distance between the upper surface 125 and lower surface 130, may be approximately 0.15 mm, and the length of each structure may be approximately 5 mm. Additionally, the angle 415 formed by each side 135, 140 with respect to the plane of the lower surface 130, or from a 90 degree angle to the lower surface 130, may be approximately 45 degrees.

It will be appreciated that the sizes described above for optical structures 120a, 120b, 120c of FIG. 4 may be implemented in any embodiments of the present invention, including those described with respect to FIGS. 1-3. Additionally, it will be appreciated that FIG. 4 is intended to illustrate only exemplary embodiments of optical structure geometries, and that additional geometries are also possible for effecting the reflection and refraction of a light incident on the optical structures to identify the presence of an ink container and the presence of ink in an ink container as described herein. Therefore, it will be appreciated that the present invention is intended to include any optical structure geometries having at least one upper surface that is substantially parallel to a surface of an ink reservoir, and at least one face, e.g., a side, that is angled with respect to the upper surface of the optical structure and the surface of an ink reservoir.

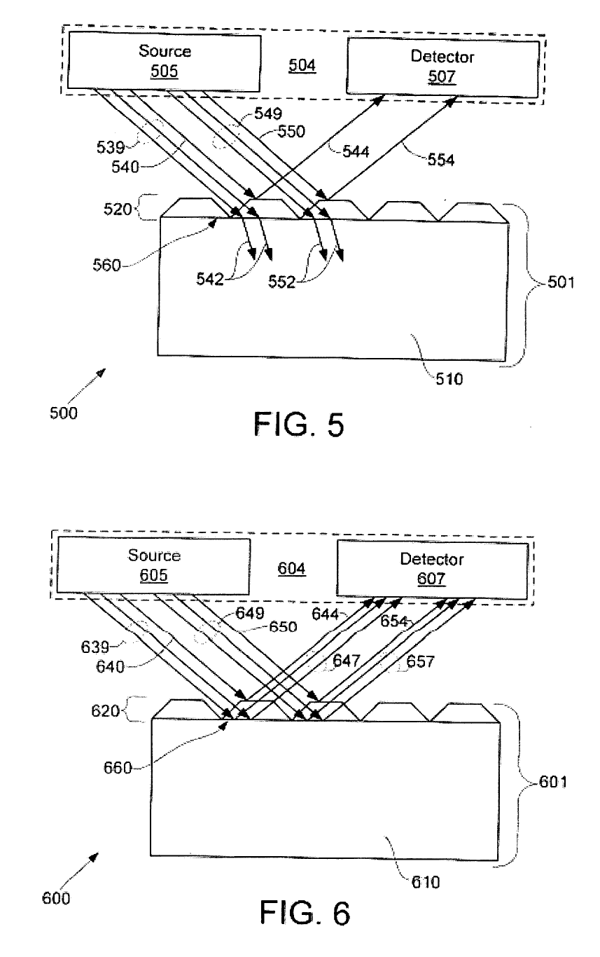

FIG. 5 is an illustrative ink and container presence detection system 500 including an ink container 501 having an ink reservoir 510 with ink therein, according to an embodiment of the present invention. As illustrated in FIG. 5, the ink container 501 includes a plurality of optical structures 520 on at least one side of the container, where the container 501 and optical structures 520 are positioned opposite an optical unit 504. This positioning may be effected by the placement of the ink container 501 on a moveable carriage that, as is known in the art, positions the ink container, and more particularly, positions the optical structures 520, in front of the optical unit 504. The optical unit 504 can include a source 505 for emitting light toward the ink container 501, and more particularly, the optical structures 520. According to an aspect of the invention, the source 505 may emit an infrared light toward the optical structures 520. The optical unit 504 can also include a detector 507 for detecting light reflected from the ink container 501.

Although not illustrated in FIG. 5, the optical unit 504 may be coupled to hardware and/or software that can control the emission of light from the source 505 and can interpret the measurements of light received by the detector 507 in response to the emission of light from the source 505. Therefore, the methods of the present invention describing the use of various measurements made by the detector 507 to determine the presence of a container and/or ink in a container may be implemented by hardware and/or software in communication with the optical unit 504.

The presence of a container in front of the optical unit 504 can be determined by measuring the amount of light reflected by the container 501 toward the detector 507 in response to incident light received thereon emitted by the source 505. It will be appreciated that when no container is present in front of the optical unit 504, there will be very low or no reflected light measured by the detector 507, as there is no surface present before the source to reflect light. On the other hand, a medium or high measurement of reflected light received by the detector 507 in response to light emitted toward the ink container will be indicative of the presence of an ink container. As described in detail below, as a result of the shape of the optical structures of the present invention, this holds true for containers according to the present invention that contain ink or fail to contain ink.

It will further be appreciated that the presence of ink within a container can be determined based on the amount of reflection of light that occurs at the ink/reservoir interface. When ink is absent in an ink reservoir, light reflects completely at the ink reservoir interface and results in a high reflected signal. On the other hand, when ink is present in the reservoir, most of the light refracts into the ink, resulting in a medium reflected light signal.

Referring once again to the illustrative ink and container presence detection system 500 of FIG. 5, the optical structures 520 receive incident light 539, 540, 549, 550 projected thereon by the source 505. In the illustrative example shown in FIG. 5, incident, reflected and refracted light is illustrated using light rays 539, 540, 549, 550, 544, 554, 542, 552. As shown, at least a portion of the incident light 540, 550 is projected onto the upper surface of the optical structures 520. The upper surface portions of the optical structures are used to effect reflection of light toward the detector 507 for use in container sensing. In particular, the light 540, 550 incident on the upper surfaces of the optical structures 520 is reflected 544, 554 toward the detector 507.

The remaining light 539, 549 emitted from the source 505 is incident on the sloped sides of the optical structures 520. Because of the angle of incidence of the light 539, 549 on the sloped sides of the optical structures 520, the light passes through the optical structures 520 and is incident at the ink/reservoir interface 560. As shown in FIG. 5, when ink is present in the reservoir 510, the light incident at the ink/reservoir interface 560 is refracted 542, 552 into the ink. The refraction of light into the ink within the reservoir 510 results in a medium amount of reflected light received by the detector 507.

Because the surface area of the upper surfaces of the optical structures 520 that receive incident light from the source 505 may cover a significant percentage of the area covered by the optical structures 520 for receiving light, such as fifty percent or more, a medium or high amount of reflected light measured by the detector 507 is indicative of the existence of an ink container. As noted above, where no ink container is present before the optical unit 504, very little or no light would be reflected toward the detector. According to one aspect of the invention, the optical unit 504 may communicate the measurement of light to software and/or hardware internal or external to the optical unit 504 that is operative to compare the amount of reflected light to pre-stored values to determine whether the measurement is indicative of low, medium, or high reflectivity.

As shown in FIG. 5, the presence of ink in the reservoir 510 results in some of the light incident on the optical structures 520 being refracted into the ink, which in turn results in a medium amount of light reflected toward the detector 507. As will next be explained with reference to FIG. 6, the existence of ink in the reservoir 510 may be determined as a result of the medium amount of light reflected toward the detector 507.

FIG. 6 shows an illustrative ink and container presence detection system 600 of FIG. 5 having an ink container 601 having an ink reservoir 610 with no ink therein, according to an embodiment of the present invention. The ink and container presence detection system 600 of FIG. 6 is identical to the ink container presence detection system 500 of FIG. 5, but for the lack of ink in the reservoir 600 in FIG. 6. As shown in FIG. 6, at least a portion of the incident light 640, 650 is projected onto the upper surface of the optical structures 620 by a source 605 of an optical unit 604. The upper surface portions of the optical structures 620 are used to effect reflection of light toward the detector 607 for use in container sensing. In particular, the light 640, 650 incident on upper surfaces of the optical structures 620 is reflected 644, 654 toward the detector 607 in the same manner as it was reflected in the system 500 of FIG. 5.

The remaining light 639, 649 emitted from the source 605 is incident on the sloped sides of the optical structures 620. Because of the angle of incidence of the light 639, 649 on the sloped sides of the optical structures 620, the light passes through the optical structures 620 and is incident at the ink/reservoir interface 660. Unlike the illustrative embodiment of FIG. 5, ink is not present in the reservoir 610. As a result, the light incident at the ink/reservoir interface 660 is reflected 647, 657 toward the detector 607. The reflection of light from both the upper surfaces of the optical structures 620 and from the ink/reservoir interface 660 results in a high amount of light reflected toward the detector 607.

As will be appreciated with reference to FIGS. 5 and 6, a medium amount of reflected light received by the detector is indicative of an ink container having ink therein, as in the illustrative example of FIG. 5. On the other hand, a high amount of reflected light received by the detector is indicative of an ink container having no ink therein, as in the illustrative example of FIG. 6. As noted above, a low amount of reflected light received by the detector is indicative of no container.

According to an embodiment of the invention, the optical unit 504 may communicate the measurement of light to software and/or hardware internal or external to the optical unit 504 that is operative to compare the amount of reflected light to pre-stored values to determine whether the measurement is indicative of low, medium, or high reflectivity. This may occur via a means for determining including of software and/or hardware (which may include the optical unit) for performing the functions described herein with respect to FIGS. 5-7 for determining whether an ink container and/or ink is present in response to a measurement of the amount of reflected light received by the optical unit. According to one aspect of the invention, the pre-stored values may be one or more threshold values used to determine whether a measurement is low, medium, or high. Based on the results of the comparison, the amount of reflected light received by the detector results in a determination as to whether an ink container is positioned before an optical unit, and if an ink container is present, whether the ink container has ink therein.

According to an aspect of the invention, the detector measures the amount of light received in terms of the received signal's voltage. To sufficiently determine whether a measurement is indicative of low, medium, or high reflectivity, the voltage for an ink container present with ink (medium reflectivity) may be 10 times greater than the voltage for no ink container (low reflectivity). Additionally, the voltage ration may be 2 to 1 for an ink container with no ink (high reflectivity) compared to an ink container present with ink (medium reflectivity). An illustrative example of the voltage measurements by the detector meeting such ratio criteria for two illustrative optical structures are provided in the table below:

| Optical | | Container | |
|---|---|---|---|
| Structure Height | No Ink Container | with Ink | Container with no Ink |
| 0.25 mm | 7 mV | 100 mV | 600 mV |
| 0.15 mm | 7 mV | 170 mV | 520 mV |

Although not illustrated above, the above-described measurements may be altered by using tinted optical structures and/or a tinted ink container. For instance, the use of tinted optical structures may reduce the voltage levels measure by the detector for a container without ink, while the voltage ratio between voltage measurements for a container with ink and no ink container would remain the same or similar.

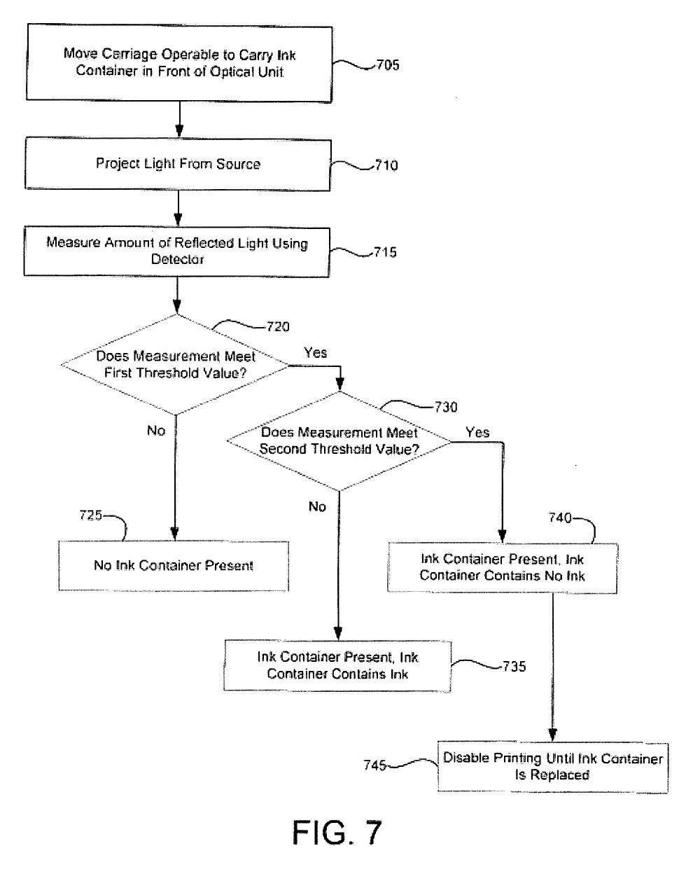

FIG. 7 is a block diagram flow chart of an ink and container presence detection method, according to an illustrative embodiment of the present invention. As shown in FIG. 7, a carriage operable to carry an ink container is first positioned in front of an optical unit (block 705). The carriage is positioned such that light emitted from the optical unit will be incident on the optical structures of the ink container, if the carriage contains an ink container. Light is then projected from a source of the optical unit (block 710), and the amount of reflected light is measured by a detector of the optical unit (block 715).

Next, the measurement of the reflected light received by the detector is compared against a first threshold value (block 720). The first threshold value may be a value that identifies whether the reflected light is a low or medium amount. For instance, if the first threshold is greater than the measurement of reflected light, then the first threshold is not met and the reflected light is deemed to be a low amount. This results in a determination that no ink container is present in the carriage (block 725). On the other hand, if the first threshold is less than the measurement of the reflected light, then the reflected light is deemed to be a medium or high amount.

A second threshold (block 730) is then used to determine if the reflected light is a medium or high amount. If the second threshold is greater than the measurement of reflected light, then the second threshold is not met and the reflected light is deemed to be a medium amount. This results in a determination that an ink container is present in the carriage, and that the ink container contains ink (block 735). On the other hand, if the second threshold is less than the measurement of the reflected light, then the reflected light is deemed to be a high amount and an ink container containing no ink is determined to be present in the carriage (block 740). Once the ink container is determined to have no ink remaining, the printer is stopped from printing until the empty ink container is replaced. This prevents the printhead from being damaged due to printing without ink.

It will be appreciated by those of ordinary skill in the art that the ink containers described in detail herein may be fixed, such that they are not positioned on a moveable carrier, as is known in the art. An example of such a container would be an ink container in an off-carrier printing system. Additionally, the optical structures may be a part of a secondary or separate ink reservoir for monitoring ink presence in a system in which ink is contained in two or more reservoirs. For instance, the presence of ink may be measured from an ink reservoir having optical structures, which provides ink to a separate ink reservoir, such as a small reservoir located at a printhead. The ink containers and/or optical structures may further be disposed on a disposable or semi-permanent printhead to detect printhead end of life or to detect when the printhead is out of ink.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of detecting the presence of an ink container and ink therein, comprising:
projecting light from a source toward a carriage, wherein the carriage is operative to retain an ink container;
measuring an amount of reflected light received by a detector; and
determining, based on the measurement of the amount of reflected light received by the detector, whether an ink container is present in the carriage and if so, whether the ink container contains ink.

2. The method of claim 1, wherein determining further comprises determining whether the measurement of the amount of reflected light exceeds a first threshold, where the first threshold is indicative of the presence or absence of the ink container in the carriage.

3. The method of claim 2, wherein determining further comprises determining whether the measurement of the amount of reflected light exceeds a second threshold, where the second threshold is indicative of the presence or absence of ink in the ink container.

4. The method of claim 1, wherein projecting light further comprises projecting light onto an ink container retained by the carriage, where the ink container comprises a plurality of optical structures having planar surfaces generally parallel to at least one surface of the ink container.

5. The method of claim 4, wherein projecting light further comprises projecting light onto an ink container retained by the carriage, where the ink container comprises a plurality of optical structures having planar surfaces oriented at an angle with respect to at least one surface of the ink container.

6. The method of claim 5, wherein the optical structures are trapezoidal in shape.

7. The method of claim 6, wherein the optical structures are trapezoidal in cross section.

8. A system for detecting the presence of an ink container and ink therein, comprising:
a light source operative to project light toward a location operable to retain an ink container having an ink reservoir for retaining ink;
a detector operative to receive any light reflected from the location; and
means for determining, based on the measurement of the amount of reflected light received by the detector, whether an ink container is present in the location and if so, whether the ink container contains ink.

9. The system of claim 8, further comprising an ink container having at least one optical structure, and wherein the location is a carriage.

10. The system of claim 9, wherein the at least one optical structure comprises a prism.

11. The system of claim 10, wherein the prism comprises a trapezoidal cross section.

12. The system of claim 10, wherein the prism protrudes from at least one substantially planar surface of the ink reservoir.

13. The system of claim 12, wherein the prism comprises a first face generally parallel to the at least one substantially planar surface of the ink reservoir, and a second face oriented at an angle with respect to the least one substantially planar surface of the ink reservoir.

14. An ink container, comprising:
an ink reservoir operable to retain ink; and
a plurality of optical structures, each of said optical structures comprising a plurality of substantially planar faces,
wherein a first face of the plurality of substantially planar faces is generally parallel to at least one surface of the ink reservoir, and wherein a second face of the plurality of substantially planar faces is oriented at an angle with respect to least one surface of the ink reservoir.

15. The ink container of claim 14, wherein each of the plurality of optical structures are substantially trapezoidal in shape.

16. The ink container of claim 14, wherein each of the plurality of optical structures are substantially trapezoidal in cross section.

17. The ink container of claim 14, wherein the plurality of optical structures are operable to reflect or refract at least a portion of light projected thereon to indicate the presence of ink in the ink reservoir.

18. The ink container of claim 17, wherein the plurality of optical structures are operable to reflect at least a portion of light projected thereon to indicate the presence of the plurality of optical structures.

19. The ink container of claim 17, wherein each of the plurality of optical structures are trapezoidal in shape
